(19) United States
(12) Patent Application Publication
(10) Pub. No.: US 2006/0286963 A1
(43) Pub. Date: Dec. 21, 2006

(54) Controlling provision of services in a communications network

(75) Inventors: Juha-Pekka Koskinen, Hameenlinna (FI); Juha R. Vallinen, Nokia (FI); Guido Triebel, Nokia (FI); Jyrki Martti, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/226,425

(22) Filed: Sep. 15, 2005

(30) Foreign Application Priority Data
Jun. 20, 2005 (GB) 0512557.0

(51) Int. Cl. H04M 11/00

(52) U.S. Cl. 455/405

(57) ABSTRACT

A method of controlling provision of services from a network element to a subscriber comprising: defining a credit threshold representing the amount of credit remaining to the subscriber below which services will no longer be provided to that subscriber; responsive to a request for a first service from the subscriber, defining a quota of service units and, in the event that the credit remaining to the subscriber after funding said quota falls below the credit threshold, returning a service control indication with said quota; responsive to a subsequent request for a second service from the subscriber, returning a defined quota of service units with said service control indication; and monitoring usage of said service units in providing the first or second service and when it is determined that the quota has been used up, acting on the service control indication to interrupt said service provision.

The present invention relates to controlling the provision of services in a communications network, particularly but not exclusively a wireless communications network. In such a network, a number of mobile users or subscribers are each entitled to request services as long as they pay for those services. The present invention is particularly concerned with the situation where a user or subscriber prepays for services by funding an account which he then draws. This is used particularly in the field of packet switched applications.

In an existing wireless communications network, real time credit control is handled by a diameter application for a variety of end user services, such as network access, session initiation protocol (SIP) services, messaging services, download services, etc. The diameter application is discussed in an Internet draft document, draft-ietf-aaa-diameter-cc-06.txt, dated 12 Aug. 2004. According to that document, the prepaid model has been shown to be very successful for instance in GSM networks where network operators offer prepaid services. However it is becoming necessary to be able to rate service information in real time and to check that the end user's account provides coverage for the requested service, prior to initiation of that service. When an account is exhausted or expired, the user must be denied the ability to compile additional chargeable events. To this end, the diameter credit control application implements a mechanism which directly interacts in real time with an account and controls or monitors the charges related to service usage. Credit control is a process of checking if credit is available, credit reservation, deduction of credit from the end users account when service is completed and refunding of reserved credit not used.

In addition of course any mechanism which is implemented must reduce as far as possible credit risk, that is a situation where a user is allowed access to services beyond those he has properly funded.

Currently, credit risk is avoided in the following way. When a service is requested, the reserved amount of money is rated, turned into a quota (for example volume or time) and delivered to a network element. With the quota, a threshold limit is also given which indicates that the network element must report when for example 80% of granted units are used. This allows a new credit reservation to be carried out while the remaining 20% of the units continue to be used in the network element.

This method is defined in 3GPP (3^{rd} Generation Partnership Protocol) standards (32.296) in addition to DCCA (Diameter Credit Control Application).

However, the above-referenced method does not prevent credit risk. When the threshold is reached, the network element will report used units to an online charging system in the network. A subscriber's account is deducted according to the used units (after rating), and a new reservation is made. As there could be several ongoing service sessions simultaneously, there is no guarantee that the credit in the account will cover the 20% of units left in the network element's possession for each of those service sessions.

It is an aim of the present invention to provide an improved way of controlling the provision of services.

One aspect of the present invention provides a method of controlling provision of services from a network element to a subscriber comprising: defining a credit threshold representing the amount of credit remaining to the subscriber below which services will no longer be provided to that subscriber; responsive to a request for a first service from the subscriber, defining a quota of service units and, in the event that the credit remaining to the subscriber after funding said quota falls below the credit threshold, returning a service control indication with said quota; responsive to a subsequent request for a second service from the subscriber, returning a defined quota of service units with said service control indication; and monitoring usage of said service units in providing the first or second service and when it is determined that the quota has been used up, acting on the service control indication to interrupt said service provision.

Another aspect of the invention provides a computer program product comprising program code means which, when loaded into a computer, carries out the following steps: responsive to a request for a first service from a subscriber in a network, defining a quota of service units and, in the event that the credit remaining to the subscriber after funding said quota falls below a credit threshold, returning a service control indication with said quota; and responsive to a subsequent request for a second service from the subscriber, returning a defined quota of service units with said service control indication.

According to another aspect of the invention, a computer program product is provided comprising program code means which, when loaded into a computer, causes a computer to carry out a method in which usage of service units are monitored in providing at least one of a first and second service, and when it is determined that a defined quota of service units has been used up, a service control indication is acted on to interrupt the service provision.

In the described embodiment, the service control indication is referred to as a final-unit-indication (FUI). In the basic embodiment, it is supposed when the FUI is received that there is no credit to be used any more and the service is interrupted either by termination or by switching to be free-of-charge/post-paid. In an enhanced embodiment, a low credit indication is provided with the service control indication when the credit falls below the credit threshold. This low credit indication allows a determination to be made as to whether or not it is necessary to implement the FUI termination of service when a new quota is requested. Thus, in this embodiment, when a new quota is requested for either the first or second service, the service provision is terminated if the low credit indication has been provided until it has been established that there is sufficient credit to fund the new quota. Otherwise, if the low credit indication has not been provided, the new quota is dispatched in line with the normal arrangement.

A further aspect of the invention provides an online charging system controlling the provision of services between a network element and a subscriber in a communications network, the online charging system comprising: means for defining a credit threshold representing the amount of credit remaining to the subscriber below which services will no longer be provided to that subscriber; means responsive to a request for a first service from the subscriber to define a quota of service units and, in the event that the credit remaining to the subscriber after funding said quota falls below the credit threshold, to return a service control indication with said quota, said means being responsive to a subsequent request for a second service from the subscriber to return a defined quota of service units with said service control indication.

The invention also provides a communications network, preferably wireless, which includes a network element comprising means for monitoring usage of said service units and providing a first or second service and when it is determined that the quota has been used up operable to act on the service control indication to interrupt said service provision.

In order to implement the enhanced embodiment discussed above, the online charging system can comprise means for providing a low credit indication with the service control indication when the credit falls below the credit threshold. The network element can comprise means for terminating the service when a new quota is requested if the low credit indication has been provided, until it has been established that there is sufficient credit to fund the new quota.

It is currently envisaged that the invention will be implemented as a new functionality for the existing diameter credit control protocol. However it will readily be appreciated that any protocol could be used to implement the invention.

As described more fully in the description which follows relating to the preferred embodiment, it will be clear that the above-described problem is solved by defining in an account a final unit limit (FUL). When the credit in the account is below FUL, all response messages sent to network elements will include a final unit indication AVP (Attribute Value Pair) no matter what service is in question. This AVP informs the network element that when these allocated units are used, the service must be terminated, or at least somehow interrupted. The interruption could take the form of an instant service termination, or a more user-friendly method. Alternatively the interaction could take the form of redirection of the service or restricted access to the service.

Using the method of the following described embodiment of the invention, an operator can define one threshold per user (not per service) to minimise credit risk.

For a better understanding of the present invention and to show how the same may be carried into effect, reference will now be made by way of example to the accompany drawings, in which:

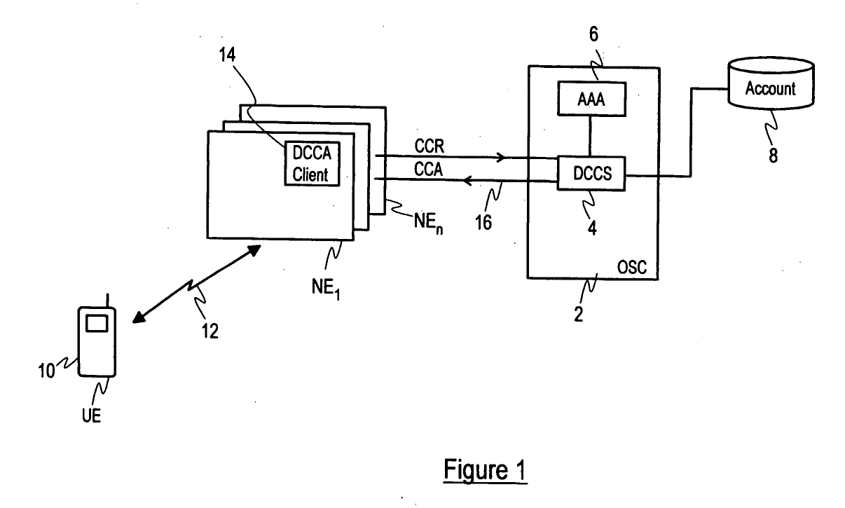

FIG. 1 is a schematic diagram of an architecture for controlling the provision of services in a network;

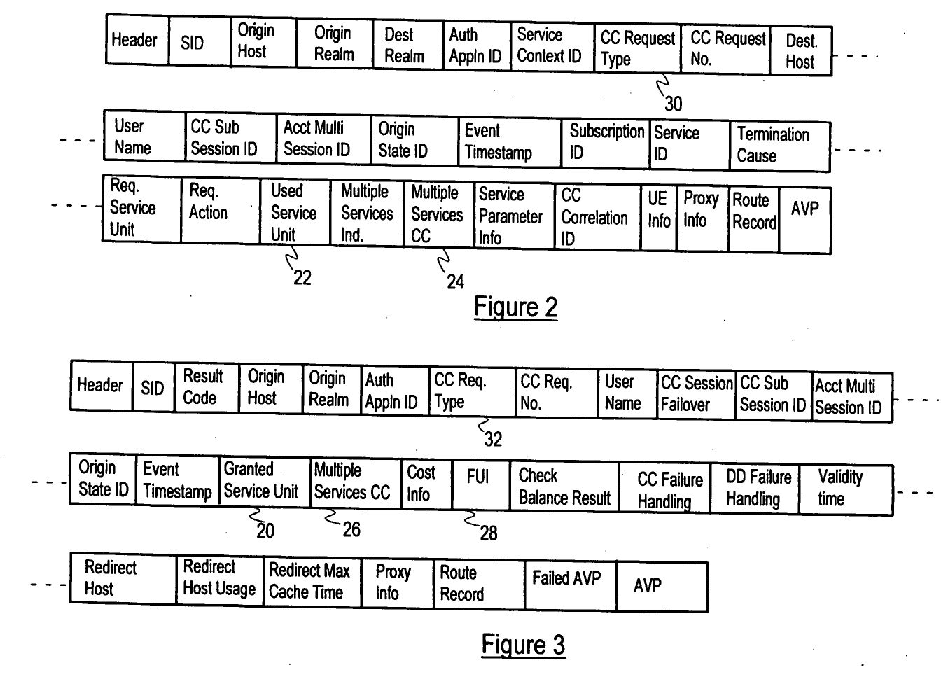

FIG. 2 illustrates the format of a credit control request message according to the diameter protocol;

FIG. 3 illustrates the format of a credit control answer message according to the diameter protocol; and

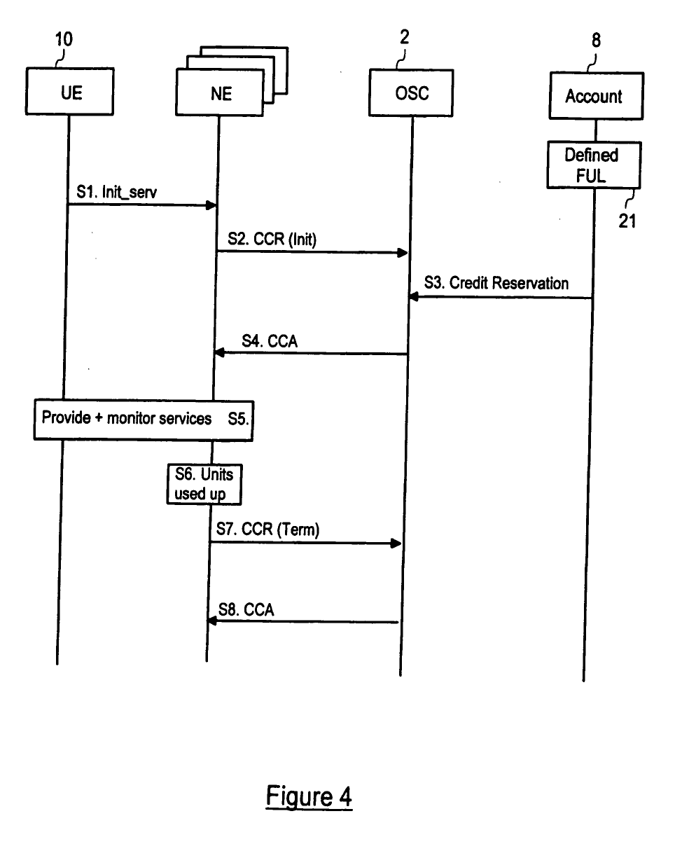

FIG. 4 is a schematic diagram illustrating implementation of a method for controlling services in a network.

FIG. 1 is a schematic block diagram of an architecture for implementing an on-line charging system (OCS) using a diameter credit control application (DCCA). The online charging system is implemented at an online service controller OSC 2 which incorporates a diameter credit control server DCCS 4 and an authentication, authorisation and accounting function AAA 6. The online service controller 2 is connected to an account database 8 which holds details of subscribers' accounts. A user equipment UE 10 allows a user (subscriber) to request services such as network access, session initiation protocol (SIP) services, messaging services, download services. The user equipment UE can take any form, but in particular can be a mobile station MS in the form of a mobile telephone or other mobile station, or any other equipment such as a personal computer (PC) or personal digital assistant (PDA). The main application of this invention is where the user equipment UE is wireless and communicates with a wireless network such as conforms with the third generation partnership protocol 3GPP for example, over a wireless link 12. The user equipment 10 can request services from a number of different network elements NE₁ . . . NEₙ which are located in the same network or in different networks. Examples of the network elements include network access server, SIP (Session Initiation Protocol) proxy and application servers such as messaging server, content server and gaming server. The network elements NE₁ . . . NEₙ are shown in communication with the online service controller 2 for charging purposes. Each network element implements a DCCA client 14 for charging purposes as is more fully herein described. The network elements NE₁ . . . NEₙ communicate with the online service controller 2 via an interface 16 which allows the exchange of messages in accordance with the DIAMETER protocol. This protocol is known, and therefore only relevant aspects of the protocol are discussed in the following. Information is transmitted under this protocol in the form of Attribute-Value Pairs (AVPs) in fields of the messages.

The diameter credit control server 4 acts as a prepaid server, performing real-time rating and credit control. The diameter credit control client 14 monitors the usage of a granted quota according to instructions returned by the diameter credit control server over the interface 16.

The diameter credit control application provides for two important messages which are exchanged over the interface 16, the credit control request message CCR and the credit control answer message CCA. The credit control request message is dispatched from the DCCA client 14 to the diameter credit control server 4 to request credit authorisation when a given service has been requested by the user equipment 10. The format of the credit control request message is shown in FIG. 2, comprising a number of fields. All the fields of the message are not discussed fully herein because they are known to a person skilled in the art, but only those relevant to the described embodiment of this invention.

The credit control answer message is returned from the diameter credit control server 4 to the DCCA client 14 to acknowledge a credit control request and to return necessary information to allow a session to be initiated by a user with appropriate credit control. The format of the credit control answer message is shown in FIG. 3. The credit authorisation process takes place before and during service delivery to the end user and requires users' authentication and authorisation (by the AAA function 6) before any request is sent to the diameter credit control service 4. The credit control application discussed herein relates to credit authorisation with money reservation.

It will be appreciated that, while money is referred to throughout, any equivalent payment or monetary units could be envisaged.

When a credit control message is received by the diameter credit control server 4 from one of the network elements NE₁ . . . NEₙ, the diameter credit control server 4 rates the request, reserves a suitable amount of money from the user's account from the account database 8 and returns the corresponding amount of credit resources in the form of units to be metered. The units can for example be data volume (kilobytes) or time (seconds). The quota is returned in the granted_service_unit AVP 20 of the credit control answer message in FIG. 3. The_granted_service unit AVP 20 is delivered with a threshold limit (e.g. 80%) in a Quota-Threshold AVP 20a, which defines the amount of service units that the DCCA client 14 can provide to the end user 10 until a new credit control request must be sent to the diameter credit control server 4. Upon reception of a successful credit authorisation answer with a certain amount of credit resources, the DCCA client 14 allows service delivery to the end user and starts monitoring the usage of the granted resources. When the defined percentage of the credit resources granted to the user have been consumed, or the service has been successfully delivered or terminated, the credit control client 14 reports back to the diameter credit control server 4 the used amount (used_service_unit AVP 22 in FIG. 2). The diameter credit control server 4 deducts the user amount from the end user's account in the account database 8 and may perform rating and make a new credit reservation if the service delivery is continuing.

With the existing DCCA protocol, multiple services for the same user are handled separately in the sense that a credit control request is made for each service and a quota for each service is returned in a corresponding credit control answer. Multiple services can be handled using a multiple services credit control AVP (denoted by reference numerals 24 in the CCR message and 26 in the CCA message) but this nevertheless requires the return of a quota per service. A quota can of course take into account that multiple services have been requested from the same user account and be reduced correspondingly.

Where the credit control answer message includes the final units that are available for a particular service, which could be the only service that has been requested or one of multiple services according to the defined quota, a final_unit_indication AVP 28 can be set in the CCA message. If this final_unit_indication AVP is set, the diameter credit control client 14 must implement certain actions at the user end once the units have been used up. The final_unit_indication AVP contains a final unit action value defining some particular action. These actions are: terminate, redirect and restrict access. In all cases, this involves the tearing down of the ongoing service session in which the subscriber has consumed all the final granted units of his quota. Where independent credit control of multiple services is being implemented, service termination for each of the services operates independently.

A difficulty arises in the context of multiple services, because a final_unit_indication AVP 28 set in a credit control answer message for one service does not impact the provision of another service provided to the same user. This therefore may allow a user to exceed his base credit limit because the final_unit_indication AVP is not set against other services (for the reason that the user has not yet exceeded his quota in those other services).

This problem is overcome in the preferred embodiment of the invention illustrated in FIG. 4 which allows an operator to define a single financial threshold per user to minimise credit risk, rather than a threshold per service.

FIG. 4 is a schematic diagram illustrating the sequence of steps to be implemented in the architecture of FIG. 1. Like numerals denote like parts as in FIG. 1. Firstly, as denoted by reference numeral 21, a final unit limit (FUL) is defined in the account database 8 per subscriber. This is the limit of the credit required for a particular subscriber to allow his services to continue to be delivered. That is, when the credit in the account is below that level, action must be taken to interrupt i.e. terminate or suspend or redirect services until further money is refunded into the account or the credit level is raised for some reason. The implementation of this feature is based on the method that when the online service controller 2 receives an answer from the account it also gets an indication if the credit is below FUL. If this is the case, the online service controller 2 sets the final unit indication AVP in the CCA message well in advance before the credit actually reaches zero.

The steps of the credit control method will now be described. According to step S1, the user equipment 10 requests services using an Init_serv message. At step S2 the network element NE dispatches a credit control request message CCR (Init) to the online service controller 2, the message being an interrogation message with the field CC request type 30 set to the value Init_request. The CCR (Init) message can either define the monetary amount to be charged or the number of requested service events.

At step S3 the credit control answer message is returned from the online service controller 2 to the network element NE with a credit reservation from the end user's account that allocates a unit quota to cover the cost of the requested service, i.e. converted from money or number of events. Credit reservation is performed after a rating function is implemented in the diameter credit control server 4. The diameter credit control server 4 returns the granted_service_unit AVP 20 in the CCA message with the value set to the allocated quota. If in the credit reservation step S3, it is determined that the final unit limit FUL is reached when the quota of granted service units is established, the final_unit_indication AVP 28 is set in the CCA message in step S4. If at the step of credit reservation it is established that there is plenty of credit remaining, there is no need to set the final_unit_indication AVP 28. It will be appreciated that when the next CCR message is received from that subscriber, pertaining to a different service, the final_unit_indication AVP 28 is also set in the corresponding CCA message, because the credit threshold has been reached. Thus, once the final_unit_indication AVP 28 has been set for one service, it is automatically set for all services for that subscriber until the account is topped up. It will be appreciated that there can be a case where the next request received from a subscriber includes a request to top up the account as well as or instead of a request for provision of a service. Nevertheless, the online service controller will return a CCA message with the final unit indication AVP set until the money has actually been credit to the account. This would have the effect that the second service would be terminated despite the fact that there was currently enough money in the account. Steps can be taken to ameliorate this by providing actions other than an immediate terminate option.

At step S5 the network element provides a service to the user equipment 10, and monitors usage of the units. When it is determined at step S6 that the units have been used up, the network element sends a credit control request message to the online service controller 2 to implement the action defined in the final unit action value of the final_unit_indication AVP 28. In the case that that action is terminate, a CCR (Term) message is dispatched, that is with a CC request type AVP set to the value Termination_request. The credit control server responds with a CCA message with a CC request type 32 set to the value Termination_request. The network element accordingly then terminates the service.

An enhanced embodiment of the invention is now described which helps to avoid credit risk by controlling the reporting in the network element NE. When there is sufficient credit, a quota-threshold AVP is utilised as described earlier. However, when there is low credit, a low credit indication is sent to the network element with the FUL AVP 28. The low credit indication can be provided in the form of a low-credit-handling AVP with possible values “halt” and “drop” for example. The level for determining low credit can be the same as FUL, or a different level. When the network element receives the low credit indication, it always terminates the service until a new quota has been granted. This solves the problem of credit risk, at the cost of a slightly degraded service experience. When the final unit indication is used the network element supposes that there is no credit to be used any more and the service is either terminated or switched to be free-of-charge/post-paid, as discussed above. With the enhancement of the low credit indication, the network element knows when there is a possible credit risk and enables it to help the service only in those cases. This gives to the network element more detailed information about how to behave when a new quota is requested from the online service controller 2. Thus, with the enhancement the possible behaviours are:
allow normal usage when the network element is waiting for an answer to a request for a new quota;
halt service until an answer to the request is received;
if the answer to the previous request already indicated that no request is allowed, terminate service.

As an additional variant, the network element can inform the end user about the low credits, especially in a case where holding a service is not appropriate (for example for a real time conversation or service).

The steps of the above-described method can be implemented at the online service controller and network element by appropriate computer programs executed by switchable processors.

1. A method of controlling provision of services from a network element to a subscriber, the method comprising:
defining a credit threshold representing an amount of credit remaining to the subscriber below which services will no longer be provided to that subscriber;
responsive to a request for a first service from the subscriber, defining a quota of service units and, in the event that credit remaining to the subscriber after funding said quota falls below the credit threshold, returning a service control indication with said quota;
responsive to a subsequent request for a second service from the subscriber, returning the defined quota of service units with said service control indication; and
monitoring usage of said service units in providing the first service or the second service and when it is determined that the quota has been used up, acting on the service control indication to interrupt a service provision.

2. The method according to claim 1, wherein said method is used to control provisions of services from the network element to the subscriber in a wireless network.

3. The method according to claim 1, wherein the request for the first service is transmitted from the subscriber as a credit control request message in accordance with a predetermined protocol.

4. The method according to claim 3, wherein the service control indication and said quota are returned to the subscriber in the form of a credit control answer message in accordance with said predetermined protocol.

5. The method according to claim 3, wherein said predetermined protocol is a diameter protocol.

6. The method according to claim 1, wherein said quota is defined as a value in an attribute value pair.

7. The method according to claim 1, wherein said service control indication is associated with an action value defining one of a plurality of actions to be implemented when it is determined that the quota has been used up.

8. The method according to claim 7, wherein said actions are selected from the group comprising terminate service, redirect service, and restrict access to service.

9. The method according to claim 1, wherein said quota is defined in terms of data volume.

10. The method according to claim 1, wherein said quota is defined in terms of time.

11. The method according to claim 1, wherein a low credit indication is provided with the service control indication when the credit falls below the credit threshold.

12. The method according to claim 11, wherein when a new quota is requested for either the first service or the second service, said service provision is terminated if the low credit indication has been provided, until it has been established that there is sufficient credit to fund the new quota.

13. An online charging system controlling the provision of services between a network element and a subscriber in a communications network, the online charging system comprising:
means for defining a credit threshold representing an amount of credit remaining to the subscriber below which services will no longer be provided to that subscriber;
means, responsive to a request for a first service from the subscriber, for defining a quota of service units and, in the event that credit remaining to the subscriber after funding said quota falls below the credit threshold, for returning a service control indication with said quota, said means being responsive to a subsequent request for a second service from the subscriber for returning the defined quota of service units with said service control indication.

14. The online charging system according to claim 13, comprising a diameter credit control server.

15. The online charging system according to claim 13, which comprises means for providing a low credit indication with the service control indication when the credit falls below the credit threshold.

16. A communications network including an online charging system according to claim 13 and a network element, the communications network comprising:
means for monitoring usage of said service units and providing the first service or the second service and when it is determined that the quota has been used up, said means being operable to act on the service control indication to interrupt a service provision.

17. The communications network according to claim 16, wherein the communications network is implemented as a wireless communications network.

18. The communications network according to claim 16, wherein said monitoring means is implemented in a diameter credit control application client.

19. The communications network according to claim 18, wherein the network element is selected from a group comprising a network access server, session initiation protocol proxy, messaging service, content service, and gaming server.

20. The communications network according to claim 16, wherein the network element comprises means for terminating service when a new quota is requested if a low credit indication has been provided, until it has been established that there is sufficient credit to fund the new quota.

21. A computer program product embodied on a computer readable medium, the computer program product comprising program code means which, when loaded into a computer, carries out the steps of:
responsive to a request for a first service from a subscriber in a network, defining a quota of service units and, in the event that credit remaining to the subscriber after funding said quota falls below a credit threshold, returning a service control indication with said quota; and
responsive to a subsequent request for a second service from the subscriber, returning the defined quota of service units with said service control indication.

22. A computer program product embodied on a computer readable medium, the computer program product comprising program code means which, when loaded into a computer, causes a computer to carry out a method comprising:
monitoring usage of service units in providing at least one of a first service and a second service, and when it is determined that a defined quota of service units has been used up, acting on a service control indication to interrupt a service provision.
